(19) United States
(12) Patent Application Publication
(10) Pub. No.: US 2017/0372068 A1
(43) Pub. Date: Dec. 28, 2017

(54) METHOD TO IDENTIFY KNOWN COMPILERS FUNCTIONS, LIBRARIES AND OBJECTS INSIDE FILES AND DATA ITEMS CONTAINING AN EXECUTABLE CODE

(71) Applicant: ALPHA MICE LTD., Tel Aviv (IL)

(72) Inventor: Israel ZIMMERMAN, Ashdod (IL)

(21) Appl. No.: 15/683,920

(22) Filed: Aug. 23, 2017

Related U.S. Application Data
(63) Continuation-in-part of application No. PCT/IL2016/050216, filed on Feb. 25, 2016.

(30) Foreign Application Priority Data
Feb. 26, 2015 (IL) 237464

(51) Int. Cl. G06F 21/56; G06F 21/57; G06F 21/53

(52) U.S. Cl. CPC G06F 21/564; G06F 21/577; G06F 21/53; G06F 2221/2149; G06F 2221/033

(57) ABSTRACT

Apparatus for identifying the functionality and structure of an executable, for examining and classifying the executable, consisting of a computerized hardware device being in communication with a computer and comprising: a first memory for storing characterizing patterns obtained offline; a second memory for temporary storing a file or a data stream to be tested; a processor, adapted to upload the characterizing patterns to the first memory, upon receiving an executable data stream to be tested from the computer; receive the data stream from the computer and store it in the second memory; compare the HASH or XOR result of the tested data stream to the stored characterizing patterns; copy the region in the tested data stream which is about the size of a function is to a temporary storage region in the second memory; replace the RVA fields with a predetermined constant value or a predetermined sequence; check the values in the RVA fields to verify whether they are compatible with the type of the required CPU and operating system and if not, cancel the tested function; calculate the Hash or XOR values for the tested function; store the tested function is in a table of results, along with identification details and start/end addresses if there is a match between the HASH or XOR result and one of the stored characterizing patterns; check to find if the table of results comprises functions, which contain other smaller overlapping functions and if it does, filter out the other smaller overlapping functions from the table of results; return the table of results to the computer, to check similarity to data entities with other programs.

This application is a continuation-in-part of PCT/IL2016/050216 filed on Feb. 25, 2016, which claims priority from IL 237464, filed on Feb. 26, 2015.

### FIELD OF THE INVENTION

The present invention relates to the field of data security. More particularly, the invention relates to a method for identifying the functionality and structure of executable files or codes, by identifying known compilers' functions, objects and libraries, including those from known sources or from a small identified code.

### BACKGROUND OF THE INVENTION

The connectivity between computers is widespread and rapidly growing. Consequently, malicious software (also known as malware) affects a great number of computer networks, which are interconnected. Malware types such as viruses, worms, Trojan horses, and others presents serious risks to millions of computer users, computerized modules, manufacturing systems, automotive etc., making them vulnerable to loss of data, identity theft, and loss of productivity, among others.

Programs for malware scanning and detection such as antiviruses employ various methods of detecting and eliminating malware from user computer systems. Such methods are based on the behavior or the content of a suspected executable. Generally, a suspected program (*.exe file) is executed in an isolated virtual environment, and if a malicious behavior is identified, the execution is blocked. Other methods compare the content of a suspected executable to a database of known malware-identifying signatures. If a known malware signature is found in a suspected file, the file is classified as malicious.

The problem with these identification methods is that when the suspected file is an executable (generally a program in the form of a file or a script that causes a computer to perform indicated tasks according to machine code instructions for a physical CPU) which includes only machine code instructions, it is almost impossible to analyze its content and identify functions that it uses, in order to understand the code that generated it, identify its inherent functions and instructions and finally determine whether or not it is malicious. Such a task is similar to reverse engineering of the executable, which may take months to reconstruct. Therefore, this solution is not practical.

Another drawback of the behavior or the content based identification methods is the fact that in many cases, the suspected file must be executed in order to learn its behavior. This cannot be done online, since during execution, the file may infect the computer that tries running it, or even the entire network.

Another disadvantage of behavior or the content based identification methods is the fact that there are many viruses that consist of a large file which consists of a chain of several executables that are attached to each other, such that the first executable activates the (attached) second executable, the second activates the (attached) third executable, and so forth. However, there are viruses that in order to evade from detection means, introduce a delay (which can exceed hours) between the activation of subsequent executables. Since each function within each executable is not signed separately, upon encountering the first executable in the chain, the detection capability will be terminated.

Also, prior art methods are not able to handle situations where hackers identify vulnerabilities which follow opening of compressed and encrypted code sections (due to the fact that these vulnerabilities continued to the binary code, following these sections). In addition, prior art methods are directed to handle executables which operate under a determined operating system (such as Windows, Linux, Android etc.) and are not adapted to effectively detect viruses that consist of a mixture of executables that operate under different operating systems.

It is therefore an object of the present invention to provide a method for identifying the functionality and structure of executable files or codes, which does not require many resources.

It is another object of the present invention to provide a method for identifying the functionality and structure of executable files or codes, which can be done online.

It is another object of the present invention to provide a method for identifying the functionality and structure of executable files or codes, which allows online undertaking of preventive and corrective actions, in case when a suspected file was found malicious.

Other objects and advantages of the invention will become apparent as the description proceeds.

### SUMMARY OF THE INVENTION

The present invention is directed to a method for identifying the functionality and structure of an executable, being a file or a code, for examining and classifying the executable, which comprises the following steps:
a) creating a database of typical patterns (such as signatures) of complete functions libraries and objects of each known target compiler or additional library functions and of their corresponding calculated hash results;
b) identifying the features of the complete functions libraries and objects in an inspected executable, without executing said inspected executable, by:
   b.1) selecting a group of bytes from the code of the executable;
   b.2) processing the group to obtain a characterizing pattern for the selected group;
   b.3) iteratively seeking a match between the characterizing pattern and a typical pattern in the database, while during each iteration, changing the size and/or the location of the group within the executable;
   b.4) upon finding a function library or object for which there is a match, seeking a match for other functions libraries and objects;
   b.5) for each found function, library or object having RVA fields, replacing the values in said RVA fields with predetermined sequence or predetermined constant values, used by a linker during compilation of said executable;
   b.6) calculating a hash using said predetermined sequence or predetermined constant values;
   b.7) seeking a match between the calculated hash of each found function, and a calculated hash result stored in the database;
   b.8) upon fining a match, determining that the function, library or object has been identified; and
c) automatically classifying the identified function, library or object, according to their level of risk.

The format of the executable file may be Portable Executable (PE) format in Windows OS or Executable and Linkable Format (ELF) in Linux OS or other type in different OS. The signatures may provide indications about using dynamic loading code like DLLs, calling import or export signatures or database functions by the executable file. The executable code may be embedded in a data file. The examined code may come from different target compilers (for example, a different CPU).

Each function of a compiler, stored in the database may include one or more of the following parameters:
Compiler name (ex. Visual C++ 2010)
Target type (ex. Windows x86 or x64)
Function name (ex. _fopen function—opens the file whose name is specified in the parameter filename and associates it with a stream that can be identified in future operations by the FILE pointer returned)
Size of the function
Array of function RVA (Relocation Virtual Address) Size and Position
Hash value of the function, where the RVA fields are replaced with a predetermined sequence or with predetermined constant values

The examined executable may be opened the as a “read only” file.

The proposed method may further comprise one or more of the following actions:
outputting and printing or analyzing the corresponding function information;
printing the information about sections inside the executable is printed along with the identified sections type;
identifying the virus or packer type of the executable or data, which is indicative whether or not the executable or the data is malicious;
neutralizing a malicious executable by blocking some of its functions and/or adapting the functions to perform benign operations by implanting other function (such as a debugger, the location of which is determined dynamically, during runtime) instead, during runtime;
identifying anti-debugging or anti-reversing engines by checking if the virus changed those functions to return false for reversers and true for anti-viruses engines;
comparing different versions of an executable code.

Alerts may be provided when any of the following events occur:
Upon identifying risky combination of embedded functions or import/export functions or DLLs;
Upon using hooking methods;
Upon identifying Different target types (CPU/DSP or OS) inside an executable file;
Upon using hardware communication libraries;
Upon using Zero-day rootkits;
Upon identifying a code inside data section or resource section or unknown section;
Upon identifying administrative functionality;
Upon identifying un-permissible functionality.

The identified function may be automatically classified by seeking a match between two different executable, in order to identify similar patterns that may be indicative of malware. Also, a “DNA”-like pattern may be created for checking the similarity of viruses or packers, to be uses as a smart signature based malware identifying engines.

Identification may be carried out using an unauthorized/unpaid functionality inside executable code. The location of the packer payload may be identified using similarity of the same packer and writing the unpacked payload to a file.

The functionality inside an executable loader engine inside an OS (like Windows or Linux) may be used to determine if the executable is malicious or not.

The functionality inside an executable may also be used to determine if a downloaded file or stored on the file system is malicious or not.

The present invention is also directed to an apparatus for identifying the functionality and structure of an executable, being a file or a code, for examining and classifying the executable. The apparatus consists of a computerized hardware device (e.g., a router, a dongle, a PC card, a switch etc.) being in communication with a computer, where the computerized hardware device comprises:
a) a first memory for storing characterizing patterns obtained offline;
b) a second memory for temporary storing a file or a data stream to be tested;
c) a processor, adapted to perform the following steps:
   c.1) upon receiving an executable data stream to be tested from the computer, uploading the characterizing patterns to the first memory;
   c.2) receiving the data stream from the computer and storing the data stream in the second memory;
   c.3) comparing the HASH or XOR result of the tested data stream to the stored characterizing patterns;
   c.4) copying the region in the tested data stream which is about the size of a complete function is to a temporary storage region in the second memory;
   c.5) for each complete function having RVA fields, replacing the values in the RVA fields with a predetermined constant value or a predetermined sequence, used by a linker during compilation of said executable;
   c.6) calculating a hash using the predetermined sequence or predetermined constant values;
   c.7) checking the values in the RVA fields to verify whether they are compatible with the type of the required CPU and operating system and if not, canceling the tested function;
   c.8) calculating the Hash or XOR values for the tested function;
   c.9) If there is a match between the HASH or XOR result and one of the stored characterizing patterns, storing the tested function is in a table of results, along with identification details and start/end addresses;
   c.10) checking to find if the table of results comprises functions, which contain other smaller overlapping functions and if it does, filtering out the other smaller overlapping functions from the table of results;
   c.11) returning the table of results to the computer, to check similarity to data entities with other programs.

### BRIEF DESCRIPTION OF THE DRAWINGS

The above and other characteristics and advantages of the invention will be better understood through the following illustrative and non-limitative detailed description of preferred embodiments thereof, with reference to the appended drawings, wherein:

FIG. 1 (prior art) illustrates generating appropriate output files from various input files, to build an executable image;

FIG. 2 (prior art) illustrates how input sections are combined into an executable image; and

FIG. 3 (prior art) illustrates the Portable Executable (PE) format and Executable and Linkable Format (ELF) of executables;

FIG. 4 illustrates an example of online identifying the functionality and structure of executable files or codes running on a PC, which is implemented in hardware that is connected to the PC; and

FIG. 5 is a flow chart showing the steps of the method proposed by the present invention, according to one embodiment.

### DETAILED DESCRIPTION OF PREFERRED EMBODIMENTS

The present invention suggests a method for identifying the functionality and structure of executable files or codes, which does not require full reverse engineering or the execution of suspected executable files or codes, in order to determine whether or not they are malicious. This is done by identifying known compilers' functions objects and libraries including those from known sources or from a small identified code such as Zero day malicious vulnerability etc., as will be explained below.

Programmers use high level compilers (a special program that processes statements written in a particular programming language and turns them into machine language or “code” that a computer's processor uses) as a part of their development environment. These compilers use internal libraries and objects that are linked to the user functionality to create the program. The programmer can link additional known libraries or objects from other sources, such as Zero-Day rootkits (an attack that exploits previously unknown vulnerability), hooking functionality, etc., and the linker gathers it to an executable image.

The method proposed by the present invention identifies the functions used inside the program and defines its purpose or behavior.

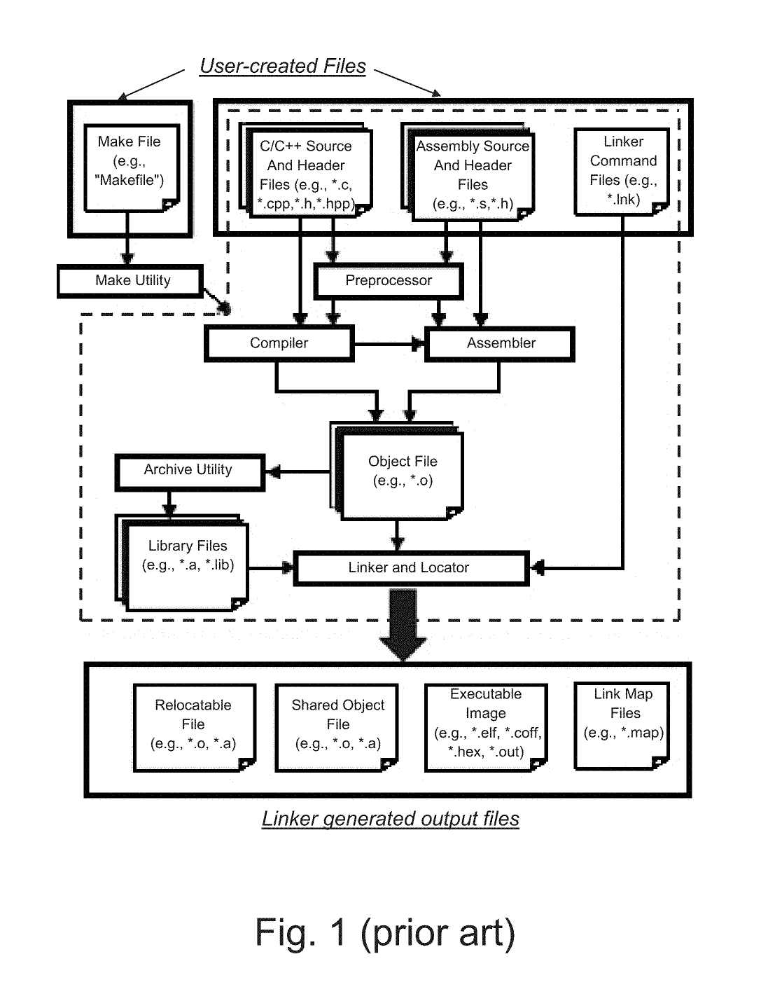

FIG. 1 (prior art) illustrates generating appropriate output files from various input files, to build an executable image, as well as the relation between a compiler and its objects/libraries. Normally, the building process of a program involves four stages and utilizes tools such as a preprocessor, compiler (a program that processes statements written in a particular programming language and turns them into machine language or code), assembler (a program that takes basic computer instructions and converts them into a pattern of bits that the computer's processor can use), and linker (a computer program that takes one or more object files generated by a compiler and combines them into a single executable file, library file, or another object file), to generate a single executable file. At the first stage (preprocessing stage) the processes include files, conditional compilation instructions and macros. At the next stage (compilation stage) an assembler code is generated using the output of the preprocessing, and the source code. At the next stage (assembly stage) the assembly (assembly language is a low-level programming language for a computer. Assembly language is converted into executable machine code by a utility program referred to as an assembler) source code and produces an assembly listing. The assembler output is stored in an object file. At the final stage (linking) one or more object files or libraries are taken as input and combines to produce a single (usually executable) file. By doing so, it resolves references to external symbols, assigns final addresses to procedures/functions and variables, and revises code and data to reflect new addresses (a process called relocation).

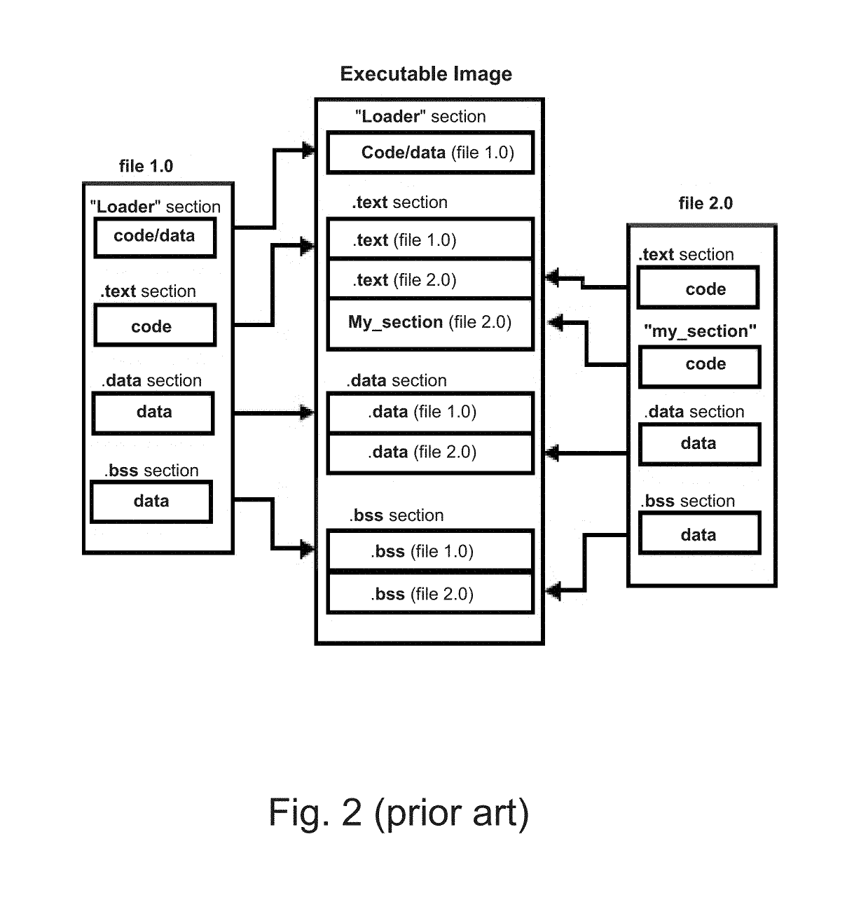

FIG. 2 (prior art) illustrates how input sections are combined into an executable image. The executable image contains three default sections (.text, .data, and .bss), as well as two developer-specified sections (in this example, “loader” and “my section”), contained in two object files generated by a compiler or assembler (file 1.0 and file 2.0).

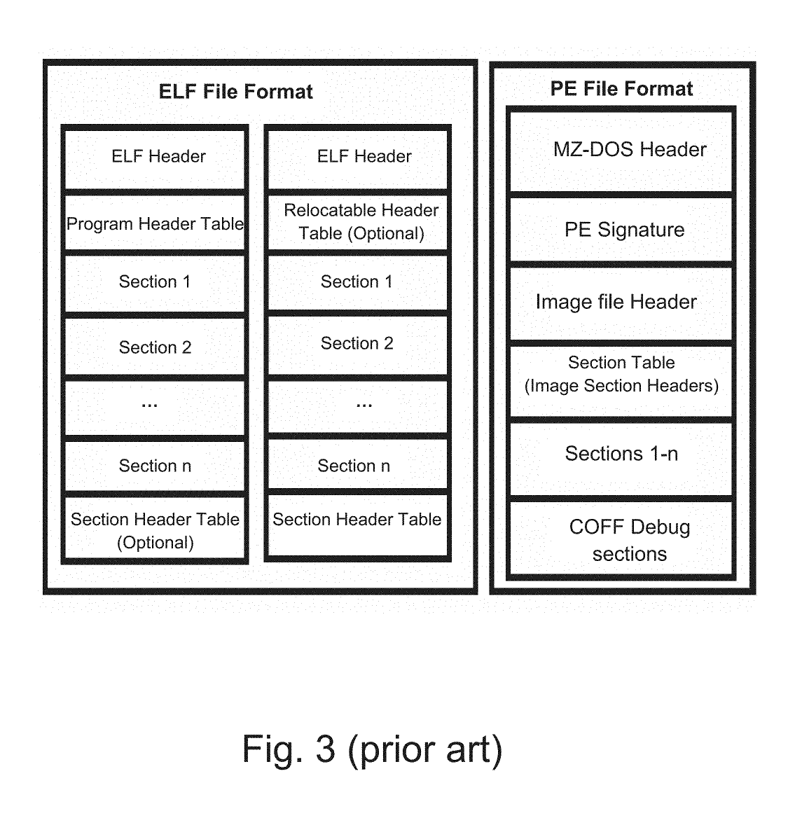

Generally, all compilers have a similar mechanism of objects, libraries and executable files. This encompasses all known executable targets (even with different operating systems). For example, the executable format in Windows OS is Portable Executable format (PE—which is a data structure that encapsulates the information necessary for the Windows OS loader to manage the wrapped executable code), and in Linux OS, the executable is Executable and Linkable Format (ELF—is a common standard file format for executables, object code, shared libraries, and core dumps). These formats are shown in FIG. 3 (prior art).

The code in Windows and Linux is located in the section called “.text” in an executable or in an object. Each object can contain one or more functions inside the object. Each function has a code, data, Relative Virtual Address (RVA—in an image file, it is the address of an item after it is loaded into memory, with the base address of the image file subtracted from it) information and symbols.

Generally, all software programs are created with known compilers, where executable files contain functions and objects from the compilers. A large portion of the executable programs are dedicated to compiler objects and functions. The main part of each compiler (except for its task to convert a code written in a programming language to machine code instructions) is the available libraries, which consist of many objects each of which including functions that are called by the machine code.

According to the method proposed by the present invention, by identifying these functions inside an executable, it is possible to obtain information which is associated with the identification of potential hazards, such as “hooking” (altering the behavior of an operating system, of applications, or of other software components by intercepting function calls or messages or events passed between software components) or the use of system administer privileges, to provide risk alerts. It is also possible to identifying potential behavior that is not legitimate, such as activation of embedded executable, etc. It is also possible to provide warnings regarding suspicious embedded code, such as illegitimate function structures that can lead to a hidden executable file. For example, it is possible to identify a function code that is embedded in the data section (such as an ActiveX code which is embedded into an MS-Word file to facilitate rich media playback) or a function code that is embedded into another code (e.g., in C# executable file).

This capability is independent of the type of operating system or compiler, since the examined file is an executable, which is less sensitive to the type of compiler that created it.

It is possible to obtain information from association of a code to the purpose of the program, such as a code that comes from different target compilers (for example, a different CPU/DSP). This can be indicative of a malicious intent that the program uses for a number of different environments. This happens in programs that are targeted to work in an administrative environment and enter/work in a different and specific target (so that it works to harm that specific function).

Another indication may be in case where the program uses hardware libraries, which are libraries that are dedicated for hardware functions (for example, USB). Using such functions can indicate a malicious intent.

These functions can be identified by creating a database with reliable signatures for the functions each compiler. This minimizes the reverse engineering sections needed to know what exactly the software is doing. Signatures may provide indications about using dynamic loading code (like: DLLs) or even database functions.

In order to create the database, data entities such as the functions libraries, strings, data segments, encryption tables (e.g. table which converts between Ciphertexts and Plaintexts) and objects of each known compiler and other known libraries are mapped offline and their typical patterns (e.g., signatures) are stored in the database, such that it will be possible to search and compare them to tested patterns of executables. For example, it is possible to store attributes of a data entity, such as the HASH or XOR result of the entity, its size, segments of bytes which are unique for this entity (and that will be used for its identification during a search), the location of bit sequences within the entity and the RVA table.

The database can also have other entities like:
1. C# binary main functions;
2. Zero-day rootkits;
3. Bytecode (form of instruction set designed for efficient execution by a software interpreter) calling signatures of different bytecode runtime engines like: C#, JAVA, Android, Python etc.

According to the present invention, compilers that are installed on their native environments are used to extract the compiler libraries and objects, in order to create a database of functions for each target compiler. Each function in the database will have the following corresponding function information:

Compiler name (ex. Visual C++ 2010)
Target type (ex. x86 or x64)
Function name (ex. _fopen)
Size of the function
Array of function RVA (Relocation Virtual Address) Size and Position
Hash (can be more than one) value of the function (RVA fields are replaced with a predetermined sequence or with predetermined constant values)

All modern compilers have built in functions (stored in a library of the compiler) which are used in combination with a written code, in order to eliminate the need to write programs in a machine language (assembler), which is very time consuming. Almost any such function calls other built in functions, which have a location that is defined by the values in their RVA. At the end of compilation, the linker of the compiler unifies all parts and functions of the program, using the RVA values.

However, the RVA values for each function vary after each compilation and also vary from program to program and in order to place each function in the right location, the linker changes the values to comply with the appropriate location addresses. Therefore, according to the present invention, the hash is calculated only after the last RVA values (resulting from the last compilation) are replaced by other values (such as “0”) before hash calculations, in order to find the right location of each function within the inspected executable.

A hash signature is calculated on the function with defined size using, for example, an MD5 (an algorithm that is used to verify data integrity) cryptographic hash function (to produce a 128-bit hash value). If the hash result matches an entity in the database, it is an indication that the tested function is the same.

According to the present invention, upon creating a signature for each specific function, it is possible to identify the same specific function inside an executable, without needing to know the name of the function. The ability to know the type and the location of each function inside an executable are important parameters for determining whether or not an executable may be malicious.

According to an embodiment of the present invention, the identifying process is performed on an unknown executable or file according to the following steps:

At the first step, the executable file is opened as a “read only” file. At the next step, a loop is created on the binary file step on 1 byte. At the next step, each signature from the database is checked. A hash function is calculated with a predetermined sequence or with predetermined constant values at the RVA fields.

At the next step, the calculated hash function is matched to the function hash. At the next step, if this function was identified, its type is stored along with the corresponding function information. At the next step, the information about sections inside the executable is gathered along with the sections information such as code sections (“.text”) position on the file. At the next step, the function information is connected to the sections information to identify where exactly the function is resides. At the next step, the information about import/export functions is stored. All the stored data can be printed or analyzed to identify a malicious code.

Many viruses for example, are compressed or encrypted executables and may be considered a self-extracting archive, where compressed data is packaged along with the relevant decompression code in an executable file. When this compressed executable is executed, the decompression code recreates the original code from the compressed code before executing it. This happens transparently so the compressed executable can be used in exactly the same way as the original. Executable compressors are often referred to as “packers” (open-source software for creating identical machine images or containers for multiple platforms from a single source configuration) each packer consists of a constant functions part and the executables which are encoded therein).

The packer part is not encrypted. The decompression is done in a certain order. This order can be recognized in order to identify the packer. This occurs with all types of known packers, such as an inline packer, a new PE packer, a resource packer etc.

The packer type may be indicative of the type of virus, in case of a malicious executable, since in many cases different viruses use the same packer.

Similarity can be identified by different types of viruses and packers, or different generations of them. Most of the viruses keep changing to create different mutations that are not recognized by the updated by signature based or heuristic behaviors.

The method proposed by the present invention provides alerts when any of the following events occur:

Upon identifying risky combination of embedded functions or import/export functions or dynamic loading such as DLLs (in Windows) or .so files (which are dynamically linked shared object libraries in Linux)
Upon using hooking methods
Upon identifying Different target types (CPU/DSP or OS) inside an executable file.
Upon using hardware communication libraries.
Upon using Zero-day rootkits.
Upon identifying code inside data section or resource section or unknown section.
Upon identifying administrative functionality.
Upon identifying un-permissible functionality.

Since the method proposed by the present invention identifies which functions are used by an executable, it is possible to dramatically reduce the time needed to extract its developer's programming (language) code.

According to another embodiment, when the executable is examined in a sandbox (an isolated computing environment used to test suspected codes), since the type and location 1 of functions that are used by an executable are known, it is also possible to block some functions and to implant other functions instead, during runtime, such that a malicious executable may be neutralized and adapted to perform benign operations. For example, if the location of a “write” function is known, it is possible to implant a debugger (a is used to test the code to be examined and to halt when specific conditions are encountered) in the sandbox (an isolated computing environment used to test suspected codes), such that the debugger will stop the execution and will extract parameters of interest that are created during execution. The debugging points can be determined dynamically, during runtime. During inspection of a suspicious executable, it is also possible to reverse the order of the functions inside it, in order to prevent potential infection.

According to another embodiment, it is possible to seek a match between two different executable, in order to identify similar patterns that may be indicative of malware and automatically classify them. The inspection and classification scheme proposed by the present invention may be done automatically, for example at the input ports to a data network, to serve as a kind of a “firewall” which can block incoming data items before penetrating into the network.

Identification and matching may be done by using signatures of functions used by known malicious executables, or checksum functions or hash. This allows also identifying trends in malware development as well as generations of viruses.

Even though the above description discussed particular operating systems, the method proposed by the present invention may be similarly implemented to almost any operating system of environment, such as Linux, Windows, Embedded real time Operating Systems (OSs) like PSOS (Portable Software On Silicon), VxWorks, Integrity, ThreadX, etc. Furthermore, after identifying libraries in a compiler, it is possible to use the proposed method for compilers of programs written in different languages working in bytecode runtime such as C#, Java, Android etc., by creating signatures for framework or runtime calling functions. This method can still identify runtime calling functions even if obfuscation is being used and it can still identify functionality of the executable. In addition, the method proposed by the present invention may be implemented in various platforms, such as IBM Mainframes, devices that operate using field-programmable gate arrays (FPGAs), the Internet of Things (IoT—a scenario in which objects or people are provided with unique identifiers and the ability to transfer data over a network without requiring human-to-human or human-to-computer interaction) or SCADA (Supervisory Control And Data Acquisition—is a category of software application program for process control), as well as Points Of Sales (POS) which still use DOS environment.

The process of identifying the functionality and structure of executable files or codes described above may be implemented using software, hardware or a combination of them. For example, it is possible to use software implementation of the process on a PC. According to another alternative, it may be implemented on a dedicated card with an Advanced RISC Machines' (ARM's) processor (a CPU that is based on the Reduced Instruction Set Computer (RISC) architecture). According to another alternative, it may be implemented on a dedicated card with a Field-Programmable Gate Array (FPGA—is an integrated circuit that can be programmed in the field after manufacture). According to another alternative, it may be implemented on a Graphics Processing Unit (GPU—a computer chip that performs rapid mathematical calculations, primarily for the purpose of rendering images). According to another alternative, it may be implemented for example, on Intel's Xeon (a microprocessor, which includes embedded FPGAs). According to another alternative, it may be implemented on an application-specific integrated circuit (ASIC—a microchip designed for a special application), etc.

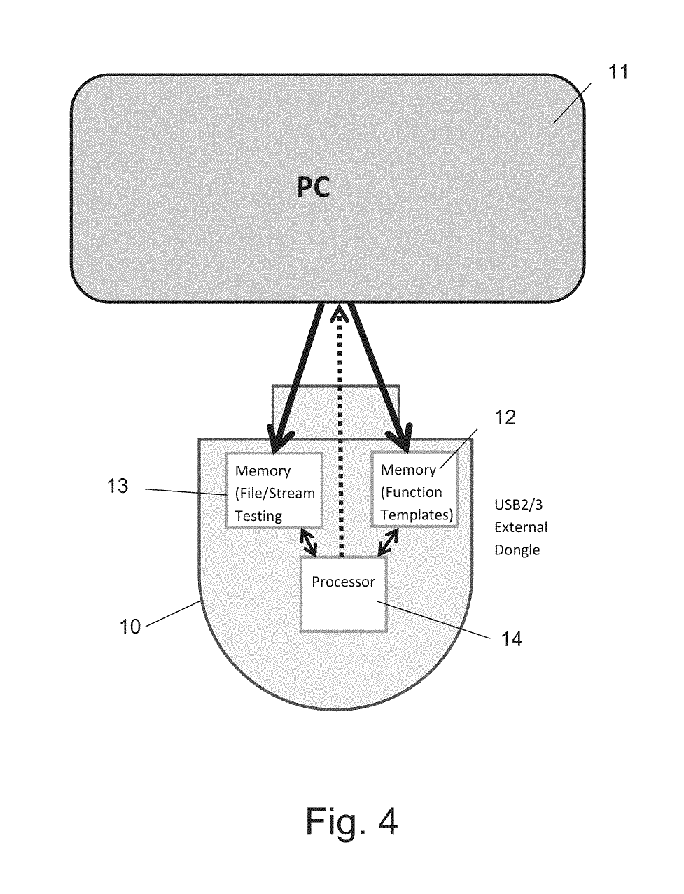

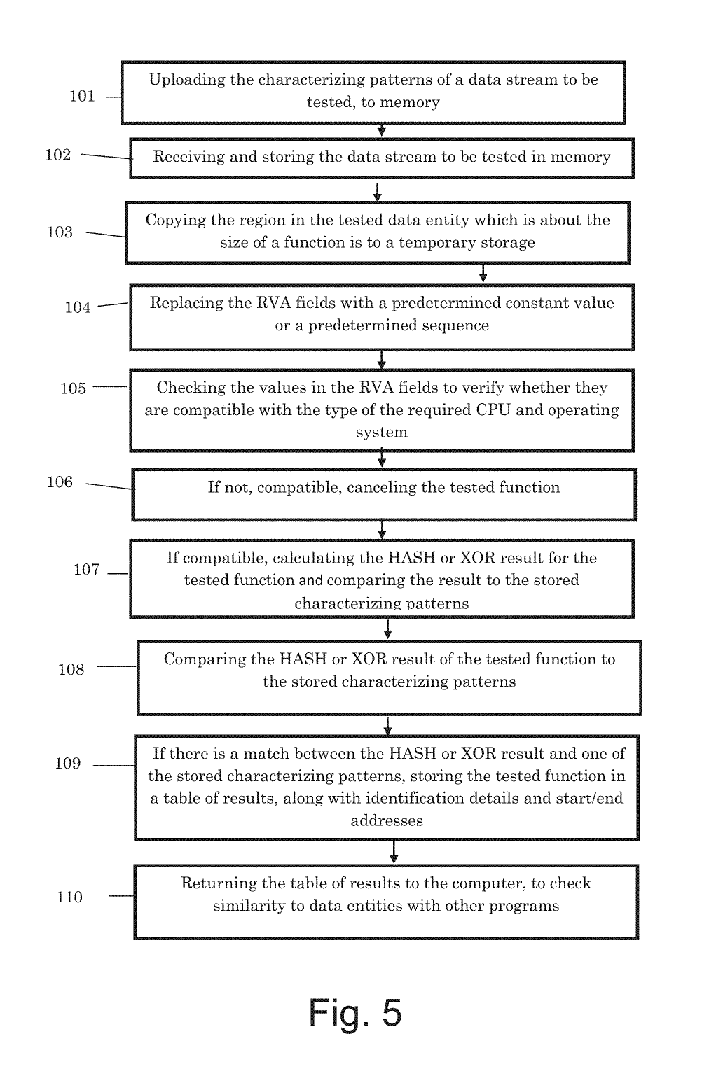

FIG. 4 illustrates an example of hardware device for online identifying the functionality and structure of executable files or codes or data streams running on a PC, which is implemented in hardware that is connected to the PC. In this example, the hardware device is a USB type external dongle 10 that is connected to a USB port of the PC 11. The dongle 10 includes a first memory 12 for storing characterizing patterns obtained offline, a second memory 13 for temporary storing a file or a data stream to be tested and a processor 14. According to one embodiment, the process (which is described in FIG. 5) includes the following steps: At the first step 101, upon receiving a data entity (such as a file or a data stream) to be tested from the PC 11, processor 14 uploads the characterizing patterns to the first memory 12. At the next step 102, the PC 11 forwards the data stream to be tested to dongle 10 and processor 14 stores it in the second memory 13. At the next step 103, the region in the tested data entity which is about the size of a function is copied to a temporary storage region in second memory 13. At the next step 104, the RVA fields are replaced with a predetermined constant value or a predetermined sequence. At the next step 105, the values in the RVA fields are checked to verify whether they are compatible with the type of the required CPU and operating system. If not, at the next step 106 the tested function is canceled (for example, the RVA fields typically represent an address in area 0x400000 or in area 0x800000, for MS-Windows or Linux, respectively). At the next step 107, the processor 14 calculates the HASH or XOR result for the tested function. At the next step 108, the processor 14 compares the HASH or XOR result of the tested function to the stored characterizing patterns. If there is a match between the HASH or XOR result and one of the stored characterizing patterns, at the next step 109 the tested function is stored in a table of results, along with identification details and start/end addresses. Processor 14 checks to find if the table of results comprises functions, which contain other smaller (overlapping) functions and if it does, the other smaller (overlapping) functions will be filtered out from the table of results. At the next step 110, the dongle 10 returns the table of results to the PC, to check similarity to data entities with other programs. This allows accurate identification of one or more functions within a tested executable, file or binary data stream, so as to detect similarity between programs or portions of programs, as well as the kind of malware.

Alternatively, the hardware device may be implemented in other forms, such as a router, a PC card, a switch or any other hardware that is configured to perform the operations described above and being in communication with a computer that should run the tested executable.

FIG. 5 is a flow chart showing the steps of the method proposed by the present invention, according to one embodiment. As such, the operations of FIG. 5, when executed, convert a computer or processing circuitry into a particular machine configured to perform an example embodiment of the present invention. Accordingly, the operations of FIG. 5 define an algorithm for configuring a computer or processing circuitry (e.g., processor) to perform an example embodiment. In some cases, a general purpose computer may be provided with an instance a processor, which performs the algorithm shown in FIG. 5 (e.g., via configuration of the processor), to transform the general purpose computer into a particular machine configured to perform an example embodiment.

### Advantages of the Present Invention

The method proposed by the present invention is based on identifying functions which are commonly used by known compilers and is not limited to executables. It can identify executable codes, which are embedded in data files. According to the present invention, each function within the executable code is signed separately, along with its sections that contain the RVA regions and is saved in the database. This allows identifying the signed functions within the executable under any type of compiler, operating system or CPU that is used.

The method proposed by the present invention is capable of detecting all functions even, if the inspected file is a dynamic file, such as an executable file that comprises a compressed section (e.g., *.zip), an encrypted section or a *.pdf section. Since each function is signed along with its RVA fields, the present invention is capable of identifying “ZeroDay” vulnerabilities (a zero-day vulnerability is an undisclosed computer-software vulnerability that hackers can exploit to adversely affect computer programs).

The method proposed by the present invention does not require executing the file—it can be performed statically, without execution, like it was a data file. This eliminates potential damage that may result from executing the file and allows substantially shortening the process of file inspection. In addition, the method proposed by the present invention continuously inspects each file in order to identify functions that it contains (and not only signed data blocks).

Since according to the present invention each function within each executable is signed separately, in case of viruses that consist of a large file which consists of a chain of several executables that are attached to each other, upon encountering the first executable in the chain, the detection capability will be maintained even if a delay between the activation of subsequent executables will be introduced. Also, detection capability will be maintained with executables which operate under different operating systems.

The above examples and description have of course been provided only for the purpose of illustration, and are not intended to limit the invention in any way. As will be appreciated by the skilled person, the invention can be carried out in a great variety of ways, employing more than one technique from those described above, other than used in the description, all without exceeding the scope of the invention.

1. A method for identifying the functionality and structure of an executable, being a file or a code, for examining and classifying said executable, comprising:
a) creating a database of typical patterns of complete functions libraries and objects of each known target compiler or additional library functions and of their corresponding calculated hash results;
b) identifying the features and locations of said complete functions libraries and objects in an inspected executable, without executing said inspected executable, by:
b.1) selecting a group of bytes from the code of said executable;
b.2) processing said group to obtain a characterizing pattern for said selected group;
b.3) iteratively seeking a match between said characterizing pattern and a typical pattern in said database, while during each iteration, changing the size and/or the location of said group within said executable;
b.4) upon finding a function library or object for which there is a match, seeking a match for other functions libraries and objects;
b.5) for each found function, library or object having Relocation Virtual Address (RVA) fields, replacing the values in said RVA fields with predetermined sequence or predetermined constant values, used by a linker during compilation of said executable;
b.6) calculating a hash using said predetermined sequence or predetermined constant values;
b.7) seeking a match between the calculated hash of each found function, and a calculated hash result stored in said database;
b.8) upon fining a match, determining that the function, library or object has been identified; and
c) automatically classifying the identified function, library or object, according to their level of risk.

2. The method according to claim 1, wherein the format of the executable file is Portable Executable (PE) format in Windows Operating System (OS) or Executable and Linkable Format (ELF) in Linux OS or other type in different OS.

3. The method according to claim 1, wherein the signatures provide indications about using dynamic loading code like DLLs, calling import or export signatures or database functions by the executable file.

4. The method according to claim 1, wherein the executable code is embedded in a data file.

5. The method according to claim 1, wherein the examined code comes from different target compilers or from a different CPU.

6. The method according to claim 1, wherein each function of a compiler, stored in the database include one or more of the following parameters:
compiler name (ex. Visual C++ 2010)
target type (ex. Windows x86 or x64)
function name (ex. _fopen)
size of the function
array of function RVA Size and Position
hash value of the function, where the RVA fields are replaced with a predetermined sequence or predetermined constant values.

7. The method according to claim 1, wherein the typical patterns are signatures.

8. The method according to claim 1, further comprising identifying the virus or packer type of the executable or data, which is indicative whether or not the executable or the data is malicious.

9. The method according to claim 1, further comprising providing alerts when any of the following events occur:
upon identifying risky combination of embedded functions or import/export functions or DLLs;
upon using hooking methods;
upon identifying Different target types (CPU/DSP or OS) inside an executable file;
upon using hardware communication libraries;
upon using Zero-day rootkits;
upon identifying a code inside data section or resource section or unknown section;
upon identifying administrative functionality;
upon identifying un-permissible functionality.

10. The method according to claim 1, further comprising neutralizing a malicious executable by blocking some of its functions and/or adapting said functions to perform benign operations by implanting other function instead, during runtime.

11. The method according to claim 1, wherein the other function is a debugger, the location of which is determined dynamically, during runtime.

12. The method according to claim 1, wherein the identified function is automatically classified by seeking a match between two different executable, in order to identify similar patterns that may be indicative of malware.

13. The method according to claim 1, wherein a “DNA”-like pattern is created, for checking the similarity of viruses or packers, to be uses as a smart signature based malware identifying engines.

14. The method according to claim 1, further comprising identifying anti-debugging or anti-reversing engines by checking if the virus changed those functions to return false for reversers and true for anti-viruses engines.

15. The method according to claim 1, further comprising comparing different versions of an executable code.

16. The method according to claim 1, wherein the location of the packer payload is identified using similarity of the same packer and writing the unpacked payload to a file.

17. The method according to claim 1, wherein the functionality inside an executable loader engine inside an OS (like Windows or Linux) is used to determine if the executable is malicious, or not.

18. The method according to claim 1, wherein the functionality inside an executable is used to determine if a downloaded file or stored on the file system is malicious, or not.

19. An apparatus for identifying the functionality and structure of an executable, being a file or a code, for examining and classifying said executable, consisting of a computerized hardware device being in communication with a computer, said computerized hardware device comprising:
a) a first memory for storing characterizing patterns obtained offline;
b) a second memory for temporary storing a file or a data stream to be tested;
c) a processor, adapted to perform the following steps:
c.1) upon receiving an executable data stream to be tested from said computer, uploading the characterizing patterns to said first memory;
c.2) receiving said data stream from said computer and storing said data stream in said second memory;
c.3) comparing the HASH or XOR result of the tested data stream to the stored characterizing patterns;
c.4) copying the region in the tested data stream which is about the size of a complete function is to a temporary storage region in said second memory;
c.5) for each complete function having Relocation Virtual Address (RVA) fields, replacing the values in said RVA fields with a predetermined constant value or a predetermined sequence, used by a linker during compilation of said executable;
c.6) calculating a hash using said predetermined sequence or predetermined constant values
c.7) checking the values in the RVA fields to verify whether they are compatible with the type of the required CPU and operating system and if not, canceling the tested function;
c.8) calculating the Hash or XOR values for the tested function;
c.9) if there is a match between the HASH or XOR result and one of the stored characterizing patterns, storing the tested function is in a table of results, along with identification details and start/end addresses;
c.10) checking to find if the table of results comprises functions, which contain other smaller overlapping functions and if it does, filtering out the other smaller overlapping functions from the table of results;
c.11) returning the table of results to said computer, to check similarity to data entities with other programs.

20. The apparatus according to claim 19, wherein the computerized hardware device may be selected from the group consisting of:
a router;
a dongle;
a PC card;
a switch.
